(19) United States
(12) Patent Application Publication
(10) Pub. No.: US 2021/0192297 A1
(43) Pub. Date: Jun. 24, 2021

(54) REINFORCEMENT LEARNING SYSTEM AND METHOD FOR GENERATING A DECISION POLICY INCLUDING FAILSAFE

(71) Applicant: Raytheon Company, Waltham, MA (US)

(72) Inventors: Kenneth L. Moore, Waltham, MA (US); Bradley A. Okresik, Waltham, MA (US)

(21) Appl. No.: 16/720,293

(22) Filed: Dec. 19, 2019

(51) Int. Cl. G06K 9/62; G06N 20/00; G06F 11/20

(52) U.S. Cl. CPC G06K 9/6297; G06F 11/2023; G06N 20/00

(57) ABSTRACT

A reinforcement learning system produces a decision policy equipped with a Failsafe decision that is invoked when machine cognition, i.e., a computed environmental awareness known as belief, is untrustworthy. The system and policy are executed on a computer system. The policy can be used for autonomous decision making or as an aid to human decision making. Also presented is a method of tuning Failsafe to a desired level of acceptable trustworthiness.

### GOVERNMENT RIGHTS

N/A

### BACKGROUND

Reinforcement Learning (RL) is a computational process that results in a policy for decision making in any state of an environment. The known Markov decision process (MDP) provides a framework for RL when the environment can be modeled and is observable. The Markov property assumes that transitioning to any future state depends only on the current state, not on a preceding sequence of transitions. An MDP is model-based RL that computes a decision policy that is optimal with respect to the model. An MDP is certain of the current state when evaluating a decision because the environment is assumed completely observable.

If the environment is only partially observable due to, for example, lack of awareness, noise, confusion, deception, etc., then an MDP must evaluate a decision with state uncertainty. State uncertainty can be represented by a random variable known as a belief state or simply “belief,” i.e., a probability distribution over all states. A partially observable MDP (POMDP) is model-based RL that formulates an optimal policy assuming state uncertainty.

Once formulated, a POMDP policy may be used in near real-time for optimal decisions in any belief state. Regardless of optimality, however, the trustworthiness of a belief state must be considered before acting on a POMDP policy's decision.

What is needed, therefore, is a method for computing a POMDP policy that suspends other decisions due to an untrustworthy belief.

### BRIEF SUMMARY OF THE INVENTION

In one aspect of the present disclosure there is a computer-implemented method of determining a Failsafe iteration solution of a Partially Observable Markov Decision Process (POMDP) model, the method comprising: defining an initial Failsafe reward parameter; defining a Failsafe Percent Belief Trustworthiness Target parameter; executing the POMDP model with the initial Failsafe reward parameter and

the Failsafe Percent Belief Trustworthiness Target parameter as input parameters resulting in a policy; analyzing the resulting policy for Failsafe selection at the Failsafe Percent Belief Trustworthiness Target parameter for each state; iteratively adjusting the Failsafe rewards; and re-executing the POMDP model a predetermined number M of iterations, wherein a change in failsafe rewards is computed prior to each iteration, wherein, after each iteration, a realized percent belief trustworthiness for each state is compared to that of a prior iteration and if any element has a change greater than a first predetermined value ∈₁, then the delta Failsafe rewards are modified and the iteration is rerun with the new reward values, wherein the method continues until a change in each state's percent belief trustworthiness is less than a second predetermined value ∈₂, wherein, at each iteration, an MSE3 value (one thousand times the mean square error) of each state's distance from the target percent belief trustworthiness is calculated, and wherein an iteration achieving a lowest MSE3 value is selected as the Failsafe iteration solution.

One aspect of the present disclosure is directed to a system comprising a processor and logic stored in one or more nontransitory, computer-readable, tangible media that are in operable communication with the processor, the logic configured to store a plurality of instructions that, when executed by the processor, causes the processor to implement a method of determining a Failsafe iteration solution of a Partially Observable Markov Decision Process (POMDP) model as described above.

In another aspect of the present disclosure there is a non-transitory computer readable media comprising instructions stored thereon that, when executed by a system comprising a processor, causes the processor to implement a method of determining a Failsafe iteration solution of a Partially Observable Markov Decision Process (POMDP) model, as set forth above.

### BRIEF DESCRIPTION OF THE DRAWINGS

Various aspects of the present disclosure are discussed below with reference to the accompanying figures. It will be appreciated that for simplicity and clarity of illustration, elements shown in the drawings have not necessarily been drawn accurately or to scale. For example, where considered appropriate, reference numerals may be repeated among the drawings to indicate corresponding or analogous elements. For purposes of clarity, however, not every component may be labeled in every drawing. The figures are provided for the purposes of illustration and explanation and are not intended as a definition of the limits of the disclosure. In the figures:

FIG. 1 is a flowchart of a Failsafe rewards algorithm in accordance with an aspect of the present disclosure;

FIGS. 2A and 2B are graphs representing performance of a system in accordance with an aspect of the present disclosure; and

FIG. 3 is a functional block diagram of a system for implementing aspects of the present disclosure.

### DETAILED DESCRIPTION

In the following detailed description, numerous specific details are set forth in order to provide a thorough understanding of the aspects of the present disclosure. It will be understood by those of ordinary skill in the art that these embodiments may be practiced without some of these specific details. In other instances, well-known methods, procedures, components and structures may not have been described in detail so as not to obscure the details of the present disclosure.

Prior to explaining at least one embodiment of the present disclosure in detail, it is to be understood that the disclosure is not limited in its application to the details of construction and the arrangement of the components set forth in the following description or illustrated in the drawings. Also, it is to be understood that the phraseology and terminology employed herein are for the purpose of description only and should not be regarded as limiting.

It is appreciated that certain features, which are, for clarity, described in the context of separate embodiments, may also be provided in combination in a single embodiment. Conversely, various features, which are described in the context of a single embodiment, may also be provided separately or in any suitable sub-combination.

In one aspect of the present disclosure, a reinforcement learning system is delivered that produces a decision policy equipped with a “Failsafe” decision that is invoked when machine cognition, i.e., a computed environmental awareness known as belief, is untrustworthy. The system and policy are executed on a computer system. As such, the policy can be used for autonomous decision making or as an aid to human decision making. Aspects of the present disclosure present a method of “tuning” Failsafe to a desired level of acceptable trustworthiness.

The failure to account for belief state trustworthiness in a POMDP renders a POMDP policy vulnerable to misinformed decisions, or worse, deliberate deception. In one aspect of the present disclosure, belief trustworthiness is defined to be the plausibility of a distribution occurring as a belief state of the modeled environment. Plausibility is defined in the present disclosure as a trustworthiness ranking of all belief state distributions. Further, another aspect of the present disclosure provides a POMDP Failsafe defined as: a decision to suspend any policy decision other than itself for pre-specified belief trustworthiness rank. In other words, the Failsafe condition suppresses any other policy action while either awaiting a trustworthy belief state or human intervention. Aspects of the present disclosure enable belief trustworthiness for which Failsafe is invoked to be specified parametrically in the POMDP model. Aspects of the present disclosure produce a reward, or immediate payoff, for invoking Failsafe in a state.

Belief Trustworthiness

Belief is a random variable that distributes over POMDP model states the probability of being in a state. POMDP state connectivity, as is known, is represented by a graph with vertices representing the states and edges representing stochastic state transitions. States may be directly connected with a single edge or remotely connected, i.e., connected through multiple edges. It should be noted that a distribution with a non-zero probability for being in a state remotely connected to the state of maximum probability may not represent a plausible belief state of the modeled environment.

In one aspect of the present disclosure, a mapping is provided that ranks a distribution's plausibility as a belief state for a given modeled environment. The mapping transforms a belief state distribution's non-zero state probabilities into monotonically increasing values for states that are increasingly remote from the state of maximum probability. Summing the values yields the belief state distribution's trustworthiness rank. The lower a belief state distribution's rank, the higher its belief trustworthiness. Conversely, the higher a belief state distribution's rank, the lower its belief trustworthiness. Normalizing distribution rank allows belief trustworthiness to be measured as a percentage, where a belief trustworthiness of 100% is any distribution containing 1, and where a belief trustworthiness of 0% is the uniform distribution.

POMDP Failsafe

Generally, as is known, an MDP is formulated with a parametric model that anticipates cost/benefit optimization to achieve intended policy behavior. A key contributor to an MDP cost/benefit optimization is a set of numerical values known as rewards that represent the immediate payoff for a decision made in a state. Decisions that benefit the intended policy behavior are valued highly (generally positive), neutral decisions are valued lower (may be non-negative or negative) and costly decisions are valued lowest (generally negative). Additional MDP model parameters are state transition probabilities and a factor selected to discount future reward. An MDP is most efficiently solved with dynamic programming that successively explores all states and iteratively evaluates for each the maximal value decision.

For an MDP, the value of making a decision in a state is evaluated with certainty of state because the environment is completely observable. For a POMDP, however, and as is generally known, the value of making a decision is evaluated from a distribution of probability over all states, i.e., a belief state. The MDP model is extended to the POMDP model by specifying observables associated with partial observation of the environment, e.g., sensor measurements. The latter are modeled by prescribing their probable occurrence upon making a decision and transitioning to a state.

One aspect of the present disclosure is a method for calculating Failsafe observation probabilities directly from a POMDP model's observation probabilities for other decisions. The method calculates the probability of an observable for Failsafe upon transitioning to a future state by additively reciprocating, i.e., subtracting from 1, the expected probability of that observable among all decisions other than Failsafe.

The rewards for computing a POMDP policy that invokes Failsafe at a prescribed percentage of belief trustworthiness cannot be specified directly nor calculated from other POMDP model parameters. Accordingly, one aspect of the present disclosure includes an algorithmic method for automatically determining Failsafe rewards subject to the aforementioned specification.

Failsafe Rewards Algorithm

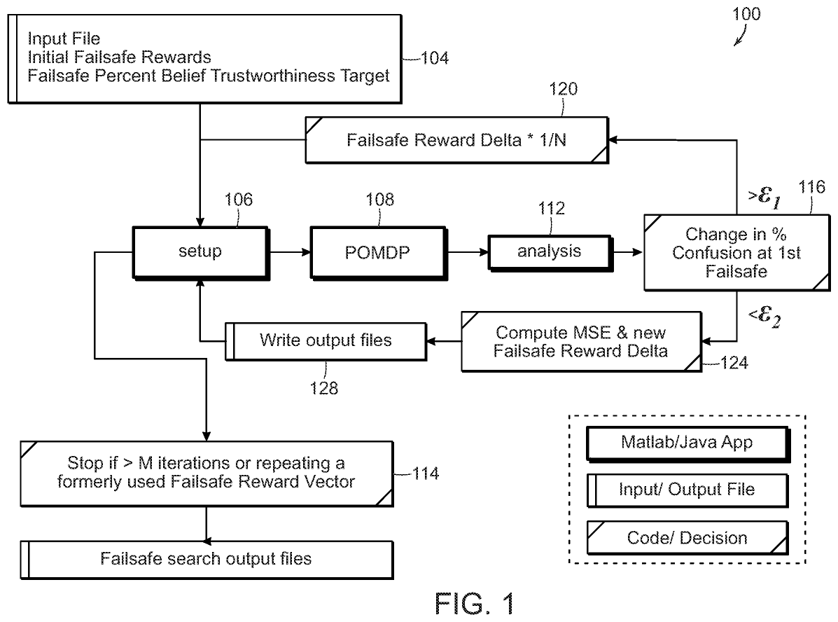

Referring now to FIG. 1, in a Failsafe Rewards Algorithm 100 in accordance with an aspect of the present disclosure, inputs 104, for example, input files, are the explicit POMDP parameters together with the Failsafe parameters including:
(a) “initial Failsafe rewards;” and
(b) a “Failsafe Percent Belief Trustworthiness Target.”

The algorithm 100 initiates by executing 108 a POMDP with the input parameters after setup 106. The resulting policy is analyzed 112 for Failsafe selection at the target percent belief trustworthiness for each state. The Failsafe rewards are then iteratively re-adjusted followed by POMDP re-execution. The algorithm 100 adjusts all state's Failsafe rewards on the first two iterations, after which only the two most extreme states' rewards are modified on each iteration, as the initial rewards have little effect on the results of the search. The Failsafe rewards will change on each iteration and the search concludes after M iterations 114. In one non-limiting example, for environments with no more than twenty (20) states, M=30.

The change in failsafe rewards 116 is computed before each iteration of the algorithm 100. After each iteration the realized percent belief trustworthiness for each state is compared 116 to that of the former iteration. If any element has excessive change, e.g., delta>∈₁, e.g., ∈₁=0.33%, then the delta Failsafe rewards are divided 120 by a small number, N, e.g., N=2, and the iteration is rerun 108 with the new smaller rewards. This process continues until no large changes are seen in each state's percent belief trustworthiness, e.g., delta<∈₂, e.g., ∈₂=0.33%. These constraints force the algorithm 100 to take small steps as it approaches a local minimum solution and prevents large jumps that can lead to repetitive cycles producing no additional value.

At each iteration the MSE3 (one thousand times the mean square error) of each state's distance from the target percent belief trustworthiness is calculated 124. The Failsafe rewards delta applied to the former Failsafe rewards and the current iteration's Failsafe rewards are then calculated 124. The iteration achieving the lowest MSE3 score is expected to be the best solution.

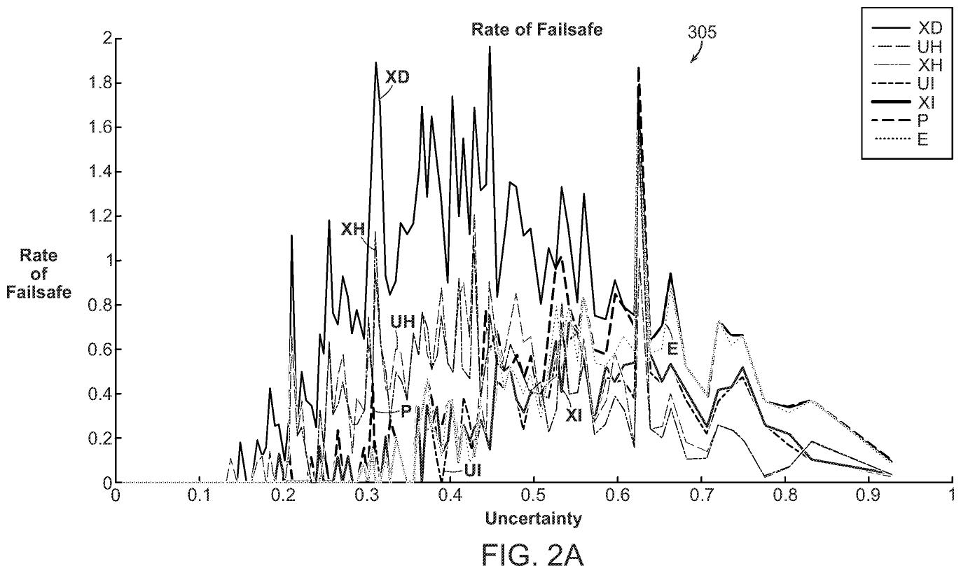

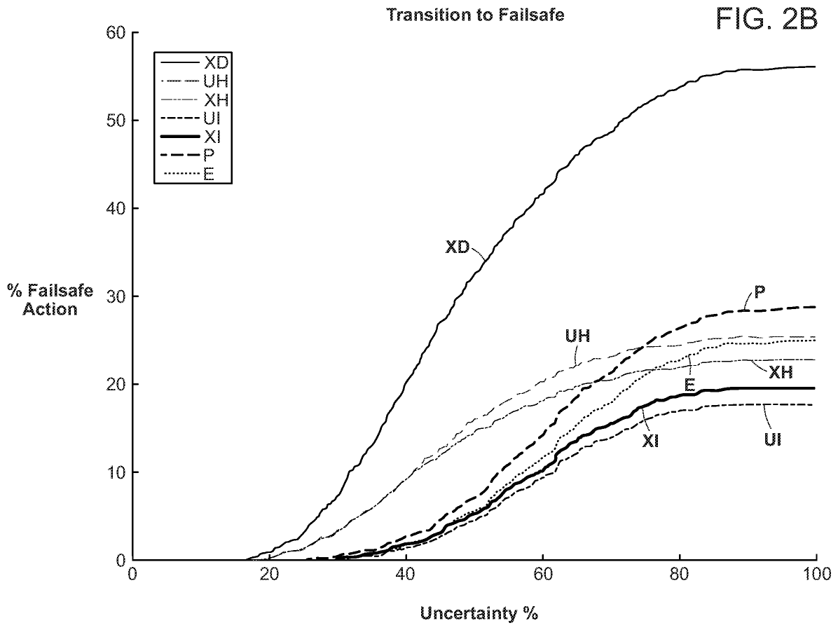

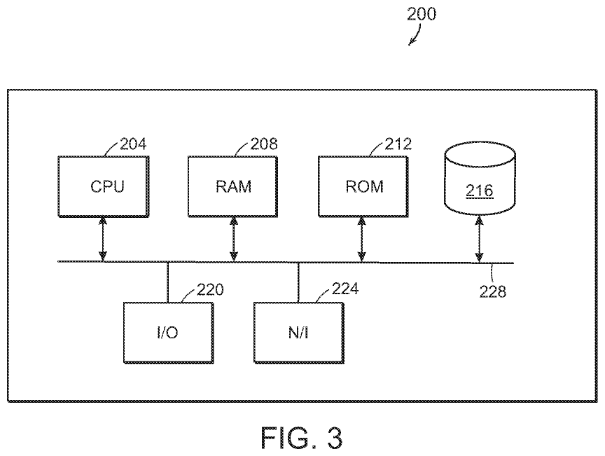

As a non-limiting example, a policy directed to deciding on the best method for improving information about a maritime vessel's intent to engage in illegal fishing will be discussed below. Referring to FIGS. 2A and 2B, performance metrics are graphically presented and show the result of each iteration for Rate-Of-Failsafe & Transition-To-Failsafe, respectively, for this policy. In this POMDP policy there are: seven (7) states, eight (8) actions and eight (8) observables; and the Design Intent is for Failsafe at ≤80% Belief Trustworthiness, i.e., ≥20% Belief Untrustworthiness.

In the exemplary policy, the environment states are phases of a vessel proceeding to an illegal fishing zone with either expected (X prefix) or uncertain (U prefix) intent. A docked vessel suspected of having an illegal intent is in a state XD. A vessel making way in the harbor is in states UH or XH and a vessel transiting in open ocean is in states UI or XI. A vessel with high potential for entering an illegal fishing zone is in state P. A vessel engaged in illegal fishing is in state E. If a belief distribution suggests a vessel is in the harbor, i.e., the vessel has non-zero probabilities for UH or XH, and, at the same time, is engaged in illegal fishing, i.e., the vessel has a non-zero probability for E, then it is ranked as untrustworthy because this is an impossible situation and Failsafe is invoked. It should be noted, however, that such a belief may be occur due to camouflage or other deceptions.

The rate at which the policy invokes Failsafe for each state as belief becomes increasingly untrustworthy is presented in FIG. 2A. Noteworthy is the high rate of Failsafe, see point 305 in FIG. 2A, with increasing belief uncertainty associated with a docked vessel in state XD (“suspected of having an illegal intent”).

The percent of Failsafe invoked in each state as belief untrustworthiness exceeds 20% is shown in FIG. 2B. The present disclosure's algorithm for Failsafe rewards provides the policy that ensures Failsafe at the prescribed 20% degradation in belief trustworthiness. The percent of Failsafe varies by state because belief trustworthiness degrades as the policy decisions in different states may differ for a given belief.

In one aspect of the present disclosure, a system 200 for providing POMDP Failsafe, as shown in FIG. 2, includes a CPU 204; RAM 208; ROM 212; a mass storage device 216, for example but not limited to, an SSD drive; an I/O interface 220 to couple to, for example, a display, keyboard/mouse or touchscreen, or the like; and a network interface module 224 to connect, either wirelessly or via a wired connection, to outside of the system 200. All of these modules are in communication with each other through a bus 228. The CPU 204 executes an operating system to operate and communicate with these various components as well as being programmed to implement aspects of the present disclosure as described herein.

Various embodiments of the above-described systems and methods may be implemented in digital electronic circuitry, in computer hardware, firmware, and/or software. The implementation can be as a computer program product, i.e., a computer program embodied in a tangible information carrier. The implementation can, for example, be in a machine-readable storage device to control the operation of data processing apparatus. The implementation can, for example, be a programmable processor, a computer and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

While the above-described embodiments generally depict a computer implemented system employing at least one processor executing program steps out of at least one memory to obtain the functions herein described, it should be recognized that the presently-described methods may be implemented via the use of software, firmware or alternatively, implemented as a dedicated hardware solution such as in a field programmable gate array (FPGA) or an application specific integrated circuit (ASIC) or via any other custom hardware implementation. Further, various functions, functionalities and/or operations may be described as being performed by or caused by software program code to simplify description or to provide an example. However, what those skilled in the art will recognize is meant by such expressions is that the functions result from execution of the program code/instructions by a computing device as described above, e.g., including a processor, a microprocessor, microcontroller, etc.

Control and data information can be electronically executed and stored on computer-readable medium. Common forms of computer-readable (also referred to as computer usable) media can include, but are not limited to including, for example, a floppy disk, a flexible disk, a hard disk, magnetic tape, or any other magnetic medium, a CD-ROM or any other optical medium, punched cards, paper tape, or any other physical or paper medium, a RAM, a PROM, and EPROM, a FLASH-EPROM, or any other memory chip or cartridge, or any other non-transitory medium from which a computer can read. From a technological standpoint, a signal encoded with functional descriptive material is similar to a computer-readable memory encoded with functional descriptive material, in that they both create a functional interrelationship with a computer. In other words, a computer is able to execute the encoded functions, regardless of whether the format is a disk or a signal.

It is to be understood that aspects of the present disclosure have been described using non-limiting detailed descriptions of embodiments thereof that are provided by way of example only and are not intended to limit the scope of the disclosure. Features and/or steps described with respect to one embodiment may be used with other embodiments and not all embodiments have all of the features and/or steps shown in a particular figure or described with respect to one of the embodiments. Variations of embodiments described will occur to persons of skill in the art.

It should be noted that some of the above described embodiments include structure, acts or details of structures and acts that may not be essential but are described as examples. Structure and/or acts described herein are replaceable by equivalents that perform the same function, even if the structure or acts are different, as known in the art, e.g., the use of multiple dedicated devices to carry out at least some of the functions described as being carried out by the processor. Therefore, the scope of the present disclosure is limited only by the elements and limitations in the claims.

Whereas many alterations and modifications of the disclosure will no doubt become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A computer-implemented method of determining a Failsafe iteration solution of a Partially Observable Markov Decision Process (POMDP) model, the method comprising:
defining an initial Failsafe reward parameter;
defining a Failsafe Percent Belief Trustworthiness Target parameter;
executing the POMDP model with the initial Failsafe reward parameter and the Failsafe Percent Belief Trustworthiness Target parameter as input parameters resulting in a policy;
analyzing the resulting policy for Failsafe selection at the Failsafe Percent Belief Trustworthiness Target parameter for each state;
iteratively adjusting the Failsafe rewards; and
re-executing the POMDP model a predetermined number M of iterations,
wherein a change in failsafe rewards is computed prior to each iteration,
wherein, after each iteration, a realized percent belief trustworthiness for each state is compared to that of a prior iteration and if any element has a change greater than a first predetermined value ∈₁, then the delta Failsafe rewards are modified and the iteration is rerun with the new reward values,
wherein the method continues until a change in each state's percent belief trustworthiness is less than a second predetermined value ∈₂,
wherein, at each iteration, an MSE3 value of each state's distance from the target percent belief trustworthiness is calculated, and
wherein an iteration achieving a lowest MSE3 value is selected as the Failsafe iteration solution.

2. The method of claim 1, further comprising:
adjusting all states' Failsafe rewards only on the first two iterations.

3. The method of claim 2, further comprising:
after the first two iterations, only modifying the two most extreme states' rewards on each iteration.

4. The method of claim 3, further comprising:
when any element has a change greater than the first predetermined value ∈₁, modifying the delta Failsafe rewards by dividing by a predetermined value.

5. A system comprising a processor and logic stored in one or more nontransitory, computer-readable, tangible media that are in operable communication with the processor, the logic configured to store a plurality of instructions that, when executed by the processor, causes the processor to implement a method of determining a Failsafe iteration solution of a Partially Observable Markov Decision Process (POMDP) model, the method comprising:
defining an initial Failsafe reward parameter;
defining a Failsafe Percent Belief Trustworthiness Target parameter;
executing the POMDP model with the initial Failsafe reward parameter and the Failsafe Percent Belief Trustworthiness Target parameter as input parameters resulting in a policy;
analyzing the resulting policy for Failsafe selection at the Failsafe Percent Belief Trustworthiness Target parameter for each state;
iteratively adjusting the Failsafe rewards; and
re-executing the POMDP model a predetermined number M of iterations,
wherein a change in failsafe rewards is computed prior to each iteration,
wherein, after each iteration, a realized percent belief trustworthiness for each state is compared to that of a prior iteration and if any element has a change greater than a first predetermined value ∈₁, then the delta Failsafe rewards are modified and the iteration is rerun with the new reward values,
wherein the method continues until a change in each state's percent belief trustworthiness is less than a second predetermined value ∈₂,
wherein, at each iteration, an MSE3 value of each state's distance from the target percent belief trustworthiness is calculated, and
wherein an iteration achieving a lowest MSE3 value is selected as the Failsafe iteration solution.

6. The system of claim 5, the method further comprising:
adjusting all states' Failsafe rewards only on the first two iterations.

7. The system of claim 6, the method further comprising:
after the first two iterations, only modifying the two most extreme states' rewards on each iteration.

8. The system of claim 7, the method further comprising:
when any element has a change greater than the first predetermined value ∈₁, modifying the delta Failsafe rewards by dividing by a predetermined value.

9. A non-transitory computer readable media comprising instructions stored thereon that, when executed by a system comprising a processor that, when executed by the processor, causes the processor to implement a method of determining a Failsafe iteration solution of a Partially Observable Markov Decision Process (POMDP) model, the method comprising:
defining an initial Failsafe reward parameter;
defining a Failsafe Percent Belief Trustworthiness Target parameter;
executing the POMDP model with the initial Failsafe reward parameter and the Failsafe Percent Belief Trustworthiness Target parameter as input parameters resulting in a policy;
analyzing the resulting policy for Failsafe selection at the Failsafe Percent Belief Trustworthiness Target parameter for each state;
iteratively adjusting the Failsafe rewards; and
re-executing the POMDP model a predetermined number M of iterations,
wherein a change in failsafe rewards is computed prior to each iteration,
wherein, after each iteration, a realized percent belief trustworthiness for each state is compared to that of a prior iteration and if any element has a change greater than a first predetermined value ∈₁, then the delta Failsafe rewards are modified and the iteration is rerun with the new reward values,
wherein the method continues until a change in each state's percent belief trustworthiness is less than a second predetermined value ∈₂,
wherein, at each iteration, an MSE3 value of each state's distance from the target percent belief trustworthiness is calculated, and
wherein an iteration achieving a lowest MSE3 value is selected as the Failsafe iteration solution.

10. The non-transitory computer readable media of claim 9, the method further comprising:
adjusting all states' Failsafe rewards only on the first two iterations.

11. The non-transitory computer readable media of claim 10, the method further comprising:
after the first two iterations, only modifying the two most extreme states' rewards on each iteration.

12. The non-transitory computer readable media of claim 11, the method further comprising:
when any element has a change greater than the first predetermined value ∈₁, modifying the delta Failsafe rewards by dividing by a predetermined value.
